(19) United States
(12) Patent Application Publication
(10) Pub. No.: US 2025/0202626 A1
(43) Pub. Date: Jun. 19, 2025

(54) TRANSMISSION OF MISSING DATA BLOCKS

(71) Applicant: Telefonaktiebolaget LM Ericsson (publ), Stockholm (SE)

(72) Inventors: Ari KERÄNEN, Helsinki (FI); Aitor HERNANDEZ HERRANZ, Stockholm (SE); Sándor KATONA, Budapest (HU); Gergely Zoltán SERES, Budapest (HU)

(73) Assignee: Telefonaktiebolaget LM Ericsson (publ), Stockholm (SE)

(21) Appl. No.: 18/851,248

(22) PCT Filed: Mar. 31, 2022
(86) PCT No.: PCT/EP2022/058729

§ 371 Date: Sep. 26, 2024

(51) Int. Cl. H04L 1/18; H04W 76/30; H04W 76/40

(52) U.S. Cl. CPC H04L 1/18; H04W 76/30; H04W 76/40

(57) ABSTRACT

Method, network device and a computer program in a communication network (100) for the assisting of an application server (130) using the Constrained Application Protocol, CoAP, in the communication of a data object (600) to client devices (110), whereby the data object comprises data blocks (601-609). The network device is operative to inform of a multicast repair functionality. The network device is operative to receive at least one indication of at least one missing data block from a client device that did not successfully receive a data block within a transmission window. The network device is operative to decide to transmit and initiate transmission of the one or missing data block via unicast, multicast or both unicast and multicast. A computer program product is also disclosed.

### TECHNICAL FIELD

The invention relates to a network device for use in a communication network, a method performed by a network device, a corresponding computer program and a corresponding computer program product.

### BACKGROUND

Devices in the category of Massive Internet of Things devices typically transmit information in a way that is highly energy efficient and often at long distances and with poor transmission capabilities. These devices use RESTful protocols such as Constrained Application Protocol (CoAP) to communicate with low computational overhead. This communication is typically done with an application server that coordinates a group of such Massive IoT devices simultaneously.

To keep such devices, also referred to as endpoints, updated in terms of software, large firmware updates are often transmitted from the application server to these endpoints, where said software is installed. This kind of update is often referred to as over the air (OTA) firmware update. Current methods of larger data objects using CoAP as specified by the CoAP block-wise protocol (see e.g. RFC7959) simply involve breaking down larger data objects into a number of blocks with a specific size. This transmission is done often through either a unicast transmission, which is from the application server to a single device, or multicast transmission, which is from the application to some devices in the network. In OTA firmware updates, the multicast option is used to update most if not all devices simultaneously.

U.S. Pat. No. 10,447,816 B2 discloses a data collector which sends an announcement of a firmware update to a plurality of endpoints. At a time indicated by the announcement, the data collector multicasts the firmware update a plurality of times. The data collector then receives indications from a plurality of endpoints that did not successfully receive all blocks of the multicast firmware update. In response, the data collector sends missing blocks to the plurality of endpoints according to the indications.

Depending on the environment, these transmissions can be error prone and thereby require retransmissions. Additionally, in RESTful protocols, the multicast transmission lacks acknowledgement of successful transmission from individual devices to prevent large numbers of acknowledgements from flooding the application server. CoAP lacks a standardized method for requesting retransmission of potential missing blocks.

### SUMMARY

An object of the invention is to enable a decrease of the number of transmissions needed to successfully transmit OTA firmware in a network using a RESTful protocol.

According to a first aspect of the invention, there is a network device in a communication network, the network device having processor circuitry and a storage unit storing instructions. The network device is configured for a task of assisting an application server using a Constrained Application Protocol, CoAP, in the communication of a data object to client devices, whereby the data object comprises data blocks. The network device is operative to inform the client devices of a multicast repair functionality enabled by the network device. The network device is operative to receive at least one indication of at least one missing data block from a client device of the client devices that did not successfully receive all data blocks of the data object within at least one transmission window of an earlier transmission in the communication associated with the client device The network device is operative to decide to transmit the one or more missing data blocks to the client device via unicast or multicast or both unicast and multicast. The network device is operative to initiate a transmission of the one or more missing data blocks according to the decision. Hereby is achieved a solution for the enablement of efficient and reliable transfer of large data objects to multiple client devices using CoAP through the use of repair capabilities with limits in the event of continued failure to repair.

In an embodiment of the first aspect, the network device is operative to determine the one or more transmission windows corresponding to the one or more missing data blocks of the client device. The transmission windows being or comprising a retransmission window that defines how long the client device should wait to receive one or more missing data blocks before indicating that the one or more data blocks have been missed. The transmission windows being or comprising a correction window that defines how long the client device should wait after communicating that the one or more missing data blocks are missing before reporting an error in the communication of the one or more data blocks. The transmission windows being or comprising a finalization phase that defines how long the communication should remain open. Hereby is achieved the reliable and efficient conclusion to a transmission of a data object.

In an embodiment of the first aspect, the transmission window or one of the transmission windows is or comprises the finalization phase and the network device is operative to end the communication of the data object once the finalization phase has elapsed. Hereby is achieved the efficient cessation of transmission of a data object.

In embodiment of the first aspect, the network device is operative to initiate transmission of information indicative of one or more transmission windows and/or the lengths of the one or more transmission windows. Hereby is achieved the enablement of flexible transmission windows and transmission window lengths between transmissions of data objects.

In an embodiment of the first aspect, the network device is operative to determine the one or more lengths of the one or more transmission windows, the one or more lengths being defined by a number of blocks or a length of time. Hereby is achieved the enablement for flexibility of length of data blocks of a data object.

In an embodiment of the first aspect, the network device is operative to decide to transmit the missing data block to the client device via unicast or multicast or both unicast and multicast based on the number of unsuccessful transmissions of the missing data block within the one or more transmission windows. Hereby is achieved a flexibility of retransmission depending on the difficulty of initial transmissions and subsequent retransmissions. This allows for either a more reliable transmission over unicast at the cost of resources or a lower cost multicast transmission or an even more reliable transmission through both unicast and multicast transmission providing diversity.

In an embodiment of the first aspect, the network device is operative to decide to transmit the missing data block to the client device via unicast or multicast or both unicast and multicast using the number of missed blocks of the data object per client device of the client devices. Hereby is achieved a flexibility of retransmission depending on the difficulty of the preceding transmission across both a single client device and multiple client devices. This allows for either a more reliable transmission over unicast at the cost of resources or a lower cost multicast transmission or an even more reliable transmission through both unicast and multicast transmission providing diversity for those client devices that might need it.

In an embodiment of the first aspect, the network device is operative to gather network information. The network information comprises a number of client devices in which the data object is to be communicated to; mobility characteristics from at least one of the plurality of clients; a number of client devices belonging to a cell; radio resource allocation of a cell; network resource allocation for a cell; available bandwidth in a cell; and/or, at least one radio parameter, derived from the reference and sounding channels, for each client device. Hereby is achieved the enablement of changing transmission configurations to account for different network conditions. This is achieved by adjusting session information to account for better or worse network conditions.

In an embodiment of the first aspect, the network device is operative to assign the client device to one or more of the multicast sessions, the unicast sessions, or both the unicast sessions and the multicast sessions. The sessions comprising at least a start time; an indication of multicast repair functionality; and information indicative of the length of the transmission windows of the client devices belonging to the session. Hereby is achieved the updating of a transmission configuration for every data object individually. This allows for the configuration to be optimized for the data object, network information and client devices.

In an embodiment of the first aspect, the network device is operative to assign the client device to one or more of the multicast sessions, the unicast sessions, or both the multicast sessions and the unicast sessions based on network information or the number of missed blocks in one or a plurality of the transmission windows per client device. The sessions differing by which blocks are to be transmitted in the session; when the blocks are transmitted; the transmission window lengths; the network settings; and/or transmission settings. Hereby is achieved the adjustment of a transmission configuration for every data object and client device individually. This allows for the configuration to be optimized for the data object, network information and client devices.

In an embodiment of the first aspect, the network device is operative to initiate transmission of information indicative of one or more sessions assigned to the client device. The network device is operative to initiate transmission of information for initialization of one or more sessions. Hereby is achieved a way to update each client device of the way the data object will be transmitted. This allows for a more efficient transfer to each client device and to the group of client devices.

In an embodiment of the first aspect, the network device is operative to determine the length of transmission windows of the sessions. The determining of the length of the transmission windows of the session being based on the number of missing blocks in one or a plurality of transmission windows from a previous multicast or unicast session to which the client device was previously assigned; the number of blocks in the data object; the number of client devices; and/or the gathered network information. Hereby is achieved the enablement of a more efficient transmission window length and a more reliable repair functionality. This allows for a more efficient use of network resources than endlessly repairing missing multicast transmissions and restarting transmission of the data object when a repair was possible and with little network resources used.

In an embodiment of the first aspect, the transmission window is or one of the transmission windows comprise the finalization phase. The network device is operative to initiate the release of the session for the client device once the finalization phase of the client device and belonging to the session has elapsed. Hereby is achieved equal repair opportunities for each data block in the data object. This allows for a more efficient use of network resources.

In an embodiment of the first aspect, the network device is operative to decide using the gathered network information, to transmit the missing data block to the client device via unicast and/or multicast. Hereby is achieved a more reliable transmission of a data object by allowing for a more reliable transmission of a missing data block if the network information indicates worse network conditions.

In an embodiment of the first aspect, the network device is operative to decide using the gathered network information, to first, before any retransmission, transmit the data blocks of the data object to the client device via multicast or unicast. Hereby is achieved a more efficient transmission of a data object by more reliably transmitting a data block via unicast from the start if the network information indicates worse network conditions.

In an embodiment of the first aspect, the network device is operative to decide to cease transmission of the missing data block. The decision is based on the data block being missed by the client device in one or more of the associated transmission windows and/or the gathered network information. Hereby is achieved a saving of network resources as data blocks that have particularly poor success with transmission or poor network conditions are considered a failure and a new more reliable session is created as opposed to wasting network resources on data blocks unlikely to be successfully transmitted.

According to a second aspect of the invention, there is provided a method performed in a network device for assisting in the retransmission of missing data blocks from a multicast transmission of a data object from an application server to a client device using Constrained Application Protocol, CoAP. The method comprises informing the client devices of a multicast repair functionality enabled by the network device. The method comprises receiving at least one indication of at least one missing data block from a client device of the client devices that did not successfully receive all data blocks of the data object within at least one transmission window of an earlier transmission in the communication associated with the client device. The method comprises deciding to transmit the one or more missing data blocks to the client device via unicast or multicast or both unicast and multicast. The method comprises initiating a transmission of the one or more missing data blocks according to the decision.

In an embodiment of the second aspect, the method comprised of the one or more transmission windows corresponding to the one or more missing data blocks of the client device. The transmission windows being or comprising a retransmission window that defines how long the client device should wait to receive one or more missing data blocks before indicating that the one or more data blocks have been missed. The transmission windows being or comprising a correction window that defines how long the client device should wait after communicating that the one or more missing data blocks are missing before reporting an error in the communication of the one or more data blocks. The transmission windows being or comprising a finalization phase that defines how long the communication should remain open.

In an embodiment of the second aspect, the transmission window or one of the transmission windows is or comprises the finalization phase. The method is comprised of ending the communication of the data object once the finalization phase has elapsed.

In an embodiment of the second aspect, the method comprising initiating transmission of information indicative of one or more transmission windows and/or the lengths of the one or more transmission windows.

In an embodiment of the second aspect, the method comprising determining the one or more lengths of the one or more transmission windows, the one or more lengths being defined by a number of blocks or a length of time.

In an embodiment of the second aspect, the method comprising deciding to transmit the missing data block to the client device via unicast or multicast or both unicast and multicast based on the number of unsuccessful transmissions of the missing data block within the one or more transmission windows.

In an embodiment of the second aspect, the method comprising deciding to transmit the missing data block to the client device via unicast or multicast or both unicast and multicast using the number of missed blocks of the data object per client device of the client devices.

In an embodiment of the second aspect, the method comprising assisting multiple application servers in communicating with multiple groups of client devices for the purpose of multicast and unicast transmissions.

In an embodiment of the second aspect, the method comprising gathering network information. The network information comprises a number of client devices in which the data object is to be communicated to; mobility characteristics from at least one of the plurality of clients; a number of client devices belonging to a cell; radio resource allocation of a cell; network resource allocation for a cell; available bandwidth in a cell; and/or, at least one radio parameter, derived from the reference and sounding channels, for each client device.

In an embodiment of the second aspect, the method comprising assigning the client device to one or more of the multicast sessions, the unicast sessions, or both the unicast sessions and the multicast sessions. The sessions comprising at least a start time; an indication of multicast repair functionality; and information indicative of the length of the transmission windows of the client devices belonging to the session.

In an embodiment of the second aspect, the method comprising assigning the client device to one or more of the multicast sessions, the unicast sessions, or both the multicast sessions and the unicast sessions based on network information or the number of missed blocks in one or a plurality of the transmission windows per client device. The sessions differing by which blocks are to be transmitted in the session; when the blocks are transmitted; the transmission window lengths; the network settings; and/or transmission settings.

In an embodiment of the second aspect, the method comprising initiating transmission of information indicative of one or more sessions assigned to the client device. The method comprising initiating transmission of information for initialization of one or more sessions.

In an embodiment of the second aspect, the method comprising determining the length of transmission windows of the sessions. The determining of the length of the transmission windows of the session being based on the number of missing blocks in one or a plurality of transmission windows from a previous multicast or unicast session to which the client device was previously assigned; the number of blocks in the data object; the number of client devices; and/or the gathered network information.

In an embodiment of the second aspect, the transmission window is or one of the transmission windows comprise the finalization phase. The method comprising initiating the release of the session for the client device once the finalization phase of the client device and belonging to the session has elapsed.

In an embodiment of the second aspect, the method comprising deciding, using the gathered network information, to transmit the missing data block to the client device via unicast and/or multicast

In an embodiment of the second aspect, the method comprising deciding, using the gathered network information, to initially transmit the data blocks of the data object to the client device via multicast or unicast.

In an embodiment of the second aspect, the method comprising deciding to not transmit the missing data block. The decision is based on the data block being missed by the client device in one or more of the associated transmission windows and/or the gathered network information.

According to a third aspect of the invention, a computer program is provided. The computer program comprises computer readable instructions for assisting an application server using a Constrained Application Protocol, CoAP, to communicate with a plurality of clients, which is run on processing circuitry of a network device. The computer readable instructions cause the network device to inform the client devices of a multicast repair functionality enabled by the network device. The computer readable instructions cause the network device to receive at least one indication of at least one missing data block from a client device of the client devices that did not successfully receive all data blocks of the data object within at least one transmission window of an earlier transmission in the communication associated with the client device. The computer readable instructions cause the network device to decide to transmit the one or more missing data blocks to the client device via unicast or multicast or both unicast and multicast. The computer readable instructions cause the network device to initiate a transmission of the one or more missing data blocks according to the decision.

In an embodiment of the third aspect, a computer program is provided. The computer program comprises computer readable instructions which is run on processing circuitry of a network device. The computer readable instructions cause the network device to perform the method according to the second aspect, including any of the embodiments of the second aspect.

According to fourth aspect of the invention, a computer program product is provided. The computer program product comprises a computer program according to the third aspect of the invention. The computer program product comprises a computer readable storage medium on which the computer program is stored.

### BRIEF DESCRIPTION OF THE DRAWINGS

The accompanying drawings, which are incorporated herein and form part of the specification, illustrate various embodiments.

FIG. 1 is a diagram showing functional units of a network according to an embodiment.

FIG. 2 is a signaling diagram showing a process according to an embodiment.

FIG. 3 is a flow chart illustrating a process of a smart proxy according to an embodiment.

FIG. 4 is a flow chart illustrating a process of an application server according to an embodiment.

FIG. 5 is a flow chart illustrating a process of a client device according to an embodiment.

FIG. 6 is a schematic diagram of a data object according to an embodiment.

FIG. 7 is a schematic diagram over time of a transmission of the data object in data blocks according to an embodiment.

FIG. 8a,b,c are a signaling diagram showing a process according to an embodiment.

FIG. 9 is a diagram showing functional units of an application server according to an embodiment.

FIG. 10 is a diagram showing functional modules of an application server according to an embodiment.

FIG. 11 Is a diagram showing functional units of a client device according to an embodiment.

FIG. 12 Is a diagram showing functional modules of a client device according to an embodiment.

FIG. 13 is a diagram showing functional units of a smart proxy according to an embodiment

FIG. 14 is a diagram showing functional modules of a smart proxy according to an embodiment; and

FIG. 15 shows one example of a computer program product comprising computer readable means according to an embodiment

### DETAILED DESCRIPTION

The invention will now be described more fully herein with reference to the accompanying drawings, in which certain embodiments of the invention are shown. This invention may, however, be embodied in many different forms and should not be construed as limited to the embodiments set forth herein. Rather, these embodiments are provided by way of example so that this disclosure will be thorough and complete, and will fully convey the scope of the invention to those skilled in the art.

Aspects of the invention provide methods for the transmission of large data files, such as firmware in the present embodiments, in a communication network comprising a plurality of devices. In certain embodiments, one or more of these devices may be referred to as user equipment (UE). In certain embodiments, the communications network may contain a plurality of devices connected in a machine to machine (M2M) deployment. To update these devices, lightweight protocols such as the Constrain Application Protocol (CoAP) are used to connect these devices to the network via an application server which may contain a smart proxy network device to assist in communication. The CoAP protocol is a RESTful protocol typically used to connect simpler devices to a network that lack the more complex capabilities of for example a computer or smartphone. The CoAP protocol has the ability to enable communication between a plurality of devices at the same time using a multicast functionality. These devices are hereinafter referred to as client devices.

The client device in the present embodiment is a device that has the capability of utilizing the CoAP protocol for communication in a communication network hereinafter referred to as a network.

A data object in the present embodiment is an object with enough data to necessitate the need to break down the object into smaller blocks of data as per the CoAP block-wise [RFC7959] protocol. These data objects may be a firmware update or other large file that should be sent to a client device.

The application server in the present embodiment is a server that hosts applications that uses the CoAP protocol for communication in a network.

A smart proxy in the present embodiment is a network device that assists the application server. The smart proxy may be a part of the application server. The smart proxy may also lie outside the application server, elsewhere in the network but in communication with the application server. The smart proxy may assist multiple application servers.

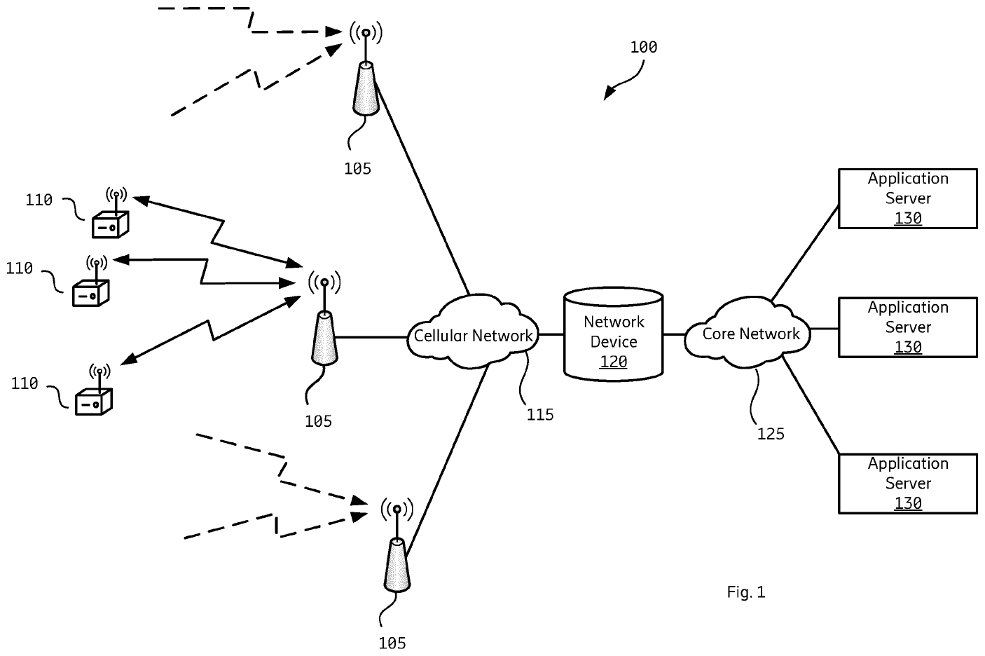

FIG. 1 schematically illustrates an embodiment of the current disclosure of a communication network 100 where access points 105 are connected to multiple client devices 110 using wireless radio frequency communication and using the CoAP. The access points are part of a cellular network 115. This cellular network may be but is not limited to an LTE or a 5G NR wireless communications network. Each access point is connected through the cellular network to a network device 120, here on also referred to as a smart proxy, and onward to a core network 125. The smart proxy which determines how to repair packets for a plurality of client devices. The core network 125 may be but is not limited to a 4^{th} or 5^{th} generation 3GPP core network. The core network is connected to an application server 130 using the CoAP protocol. The application server receives and sends information via the communications network consisting of the core network, smart proxy, cellular network, and access point to and from the client devices in the communication network. While in FIG. 1, the smart proxy is a separate network device with multiple application servers connected to it, the smart proxy may in other embodiments be located/hosted by the application server or another communication device, such as in the access point 105, the core network 125, or a separate node in the network, not shown in FIG. 1. An example of these client devices may be wireless devices connected in an M2M deployment consisting of M2M devices. The client devices may be stationary or mobile and may connect to the communication network directly or via an edge node such as a gateway.

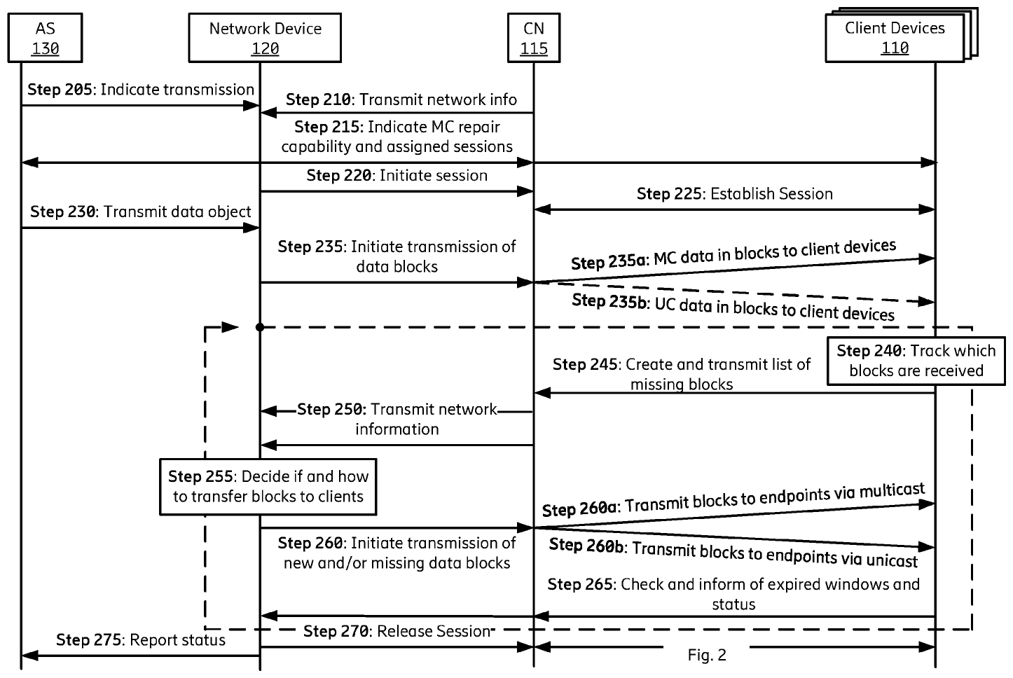

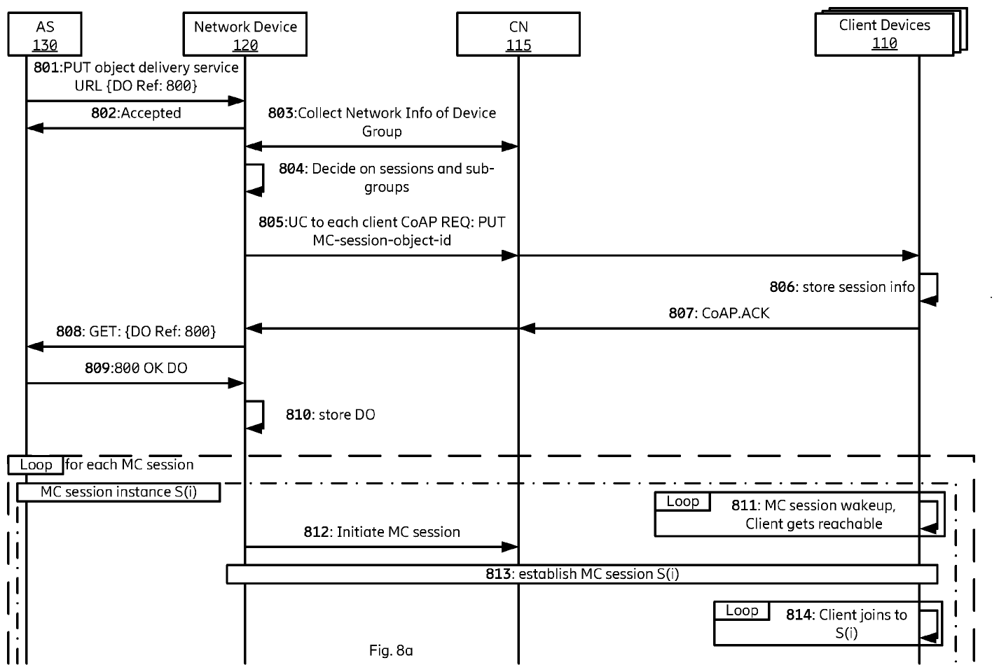

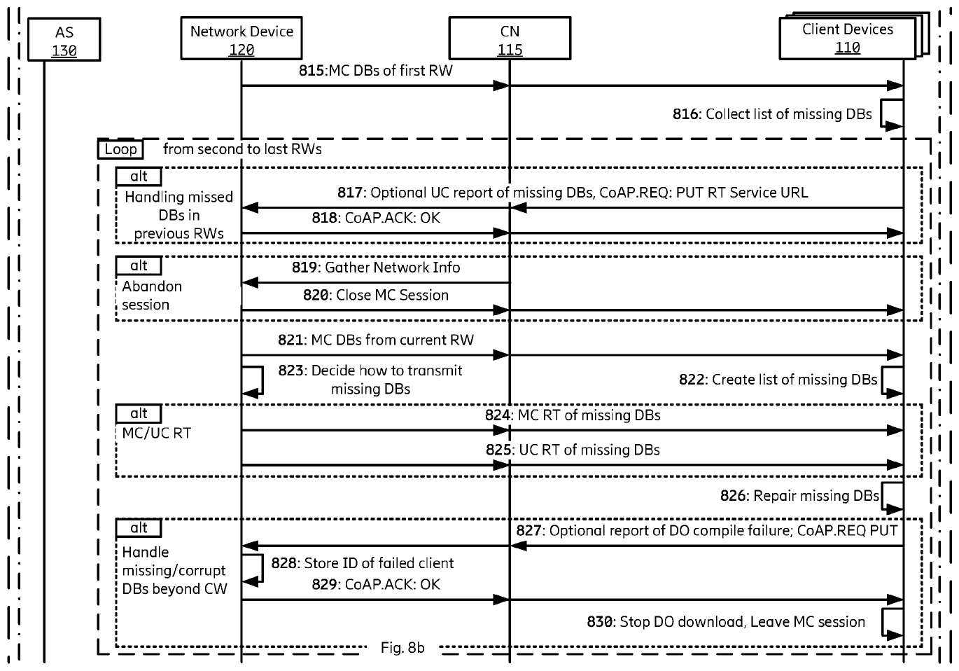

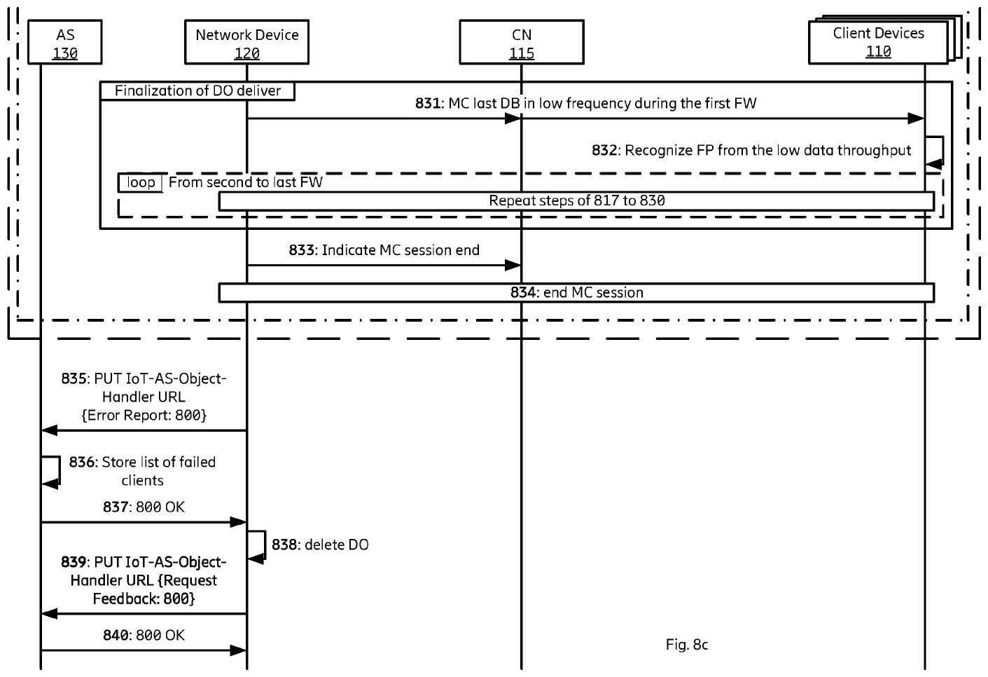

FIG. 2 illustrates a signaling diagram illustrating an embodiment of the present disclosure. The network device 120 is referred to as the smart proxy. In FIG. 2, the application server 130, labeled in the figure as AS, begins with a first step 205, where the application server indicates to the smart proxy that a large data object should be transmitted to one or more client devices in a communication network 100. An example of this step 205 may be found in step 801 of FIG. 8.

The cellular network may then, in a second step 210, transmit information regarding network information to the smart proxy. This network information may include but are not limited to the number of client devices marked for reception of the data object, mobility characteristics from at least one of the plurality of client devices, the cell conditions such as a number of devices, radio resource allocation, network resource allocation, available bandwidth, received signal strength and reliability of recent communications exchanges and radio parameters for each client device, such as power usage modes and coverage extension levels. This information may also include a number of client devices in which the data object is to be communicated to; a number of client devices belonging to a cell; radio resource allocation of a cell; network resource allocation for a cell; available bandwidth in a cell; and/or, at least one radio parameter, derived from the reference and sounding channels, for each client device. indicating to the cellular network and, by extension the client devices, that it may be able to assist the application server in providing the capability to retransmit blocks missed during a potential transmission of a data object. The network information may be gathered from records of previous transmissions, other network devices, and the client devices themselves, before or during step 210. An example of this step 210 may be found in step 803 of FIG. 8.

The proxy server then, in a third step 215, informs one or more of a plurality of client devices 110 through the cellular network 115, that the network device 120 referred to as a smart proxy and the application server 130 have the capability to retransmit any blocks missed during a potential multicast transmission of a data object. In other words, the proxy server informs the client devices of a multicast repair functionality enabled by the proxy server. An example of this might be sending multicast session information to the cellular network and the client devices such as in step 805 of FIG. 8. The smart proxy may then inform the cellular network of an initial transmission configuration where some client devices may be marked to be sent the data object via multicast and other client devices may be indicated to be sent the data object via unicast. This may be done after receiving the network information in order to decide the initial transmission configuration or be done based on a determination for the initial transmission made from other preset parameters such as data object size, number of client devices, quality of service requirements, or network information from step 210 that has been given to the smart proxy from another source This initial transmission configuration is shared with the cellular network and client devices in the form of session information. A session maybe a session for multicast transmission, unicast transmission and/or a combination of multicast transmission and unicast transmission. A client device may belong to one, multiple, all or none of the sessions created and initiated by the smart proxy. The session and the associated session information must contain a start time, an indication of multicast repair functionality and information indicative of the length of the transmission windows of the client devices belonging to the session. The session and associated session information may also differ in terms of which blocks are transmitted, when blocks are transmitted, the transmission window lengths, network settings and/or transmission settings. The smart proxy may also transmit information regarding a retransmission window 715, a correction window 725, a finalization phase 735, or a combination thereof for use by the application servers and the client devices. The smart proxy may also initiate transmission of information indicative of one or more transmission windows and/or the lengths of the one or more transmission windows. The smart proxy may initiate transmission of information indicative of one or more sessions assigned to the one or more client devices. This information may be shared in the session information or may be already known by the client devices prior to step 205. The retransmission window is used to indicate to a client device how long the client device should wait to receive at least one indication of at least one missing data block before indicating that a data block, from the data object being transmitted from the initial multicast or unicast, has been missed. Once the data block or series of blocks has been missed the client device will thereby inform the application server of a potential missing data block. In other words, the retransmission window defines how long the client device should wait to receive one or more missing data blocks before indicating that the one or more data blocks have been missed. The second being the correction window, which is used to inform the client device how long it should wait for new blocks to be resent after informing the application server that the blocks are missing before informing the application server of an error in transmission. The finalization phase is a length of time after the correction window that allows the client device to communicate a final list of missing blocks to the application server about which blocks are missing from the transmission including the last retransmission windows.

In a fourth step 220, the smart proxy will initiate the session towards the cellular network. This is done by initiating transmission of information for initialization of one or more sessions. An example of this may be found in step 812 of FIG. 8. In a fifth step 225, the cellular network will then establish the session with the client devices indicated by the smart proxy through the session information. An example of this may be found in step 813 of FIG. 8.

In a sixth step 230, the application server will transfer either the data object or a reference to the data object to the smart proxy. In one embodiment, the smart proxy divides up the data object in data blocks and prepares them for transmission via the cellular network. In another embodiment the smart proxy retrieves the data blocks from the application server using the reference when the blocks are needed by the cellular network. The smart proxy may receive the data object from a different source than the application server. An example of this step may be found in steps 808 and 809 of FIG. 8.

Once the client device has been informed of the multicast repair capability and possibly received the initial transmission configuration either before or in combination with the session being initiated and established, the smart proxy will begin transmission of the data object. The smart proxy initiates transmission of the data object to the client devices via the cellular network in a seventh step 235. This maybe done via the multicast session as shown in a sub-step 235a. Depending on the initial transmission configuration in the sessions initiated from the smart proxy, the application server may also initiate in the sub-step 235b, transmission of data object to a one or a plurality of the client devices via unicast. Both in steps 235a and 235b, these transmissions are done in a series of blocks that segment the data object into one or more pieces according to the CoAP block-wise protocol. Examples of these steps may be found in step 815 of FIG. 8.

During or after transmission, the client device then, in an eighth step 240, tracks which blocks have been received from the application server. An example of this step may be found in step 822 of FIG. 8.

Once initial transmission from the smart proxy via the cellular network is complete, the client device then, in a ninth step 245, creates a list of the missing data blocks by comparing which blocks were successfully received within one or a plurality of transmission windows against the total number of blocks that were supposed to be received from the smart proxy during the one or plurality of transmission windows. This may also be done by comparing the numbering of the blocks and checking for any discontinuities in the numbering. In this context, a missing data block may be a data block that simply was not received or a data block that was not received intact. Once the list is created, the client device then sends this list of missing blocks, in step 245, to the cellular network and onward to the smart proxy. The smart proxy will thereby receive at least one indication of at least one missing data block from a client device of the client devices that did not successfully receive all data blocks of the data object within at least one transmission window of an earlier transmission in the communication associated with the client device. An example of this step may be found in step 817 of FIG. 8.

Optionally, once the list of missing blocks has been created and transmitted, the cellular network may, in a tenth step 250, update the network information gathered previously and may send any updated network information to the smart proxy. The type of network information would be the same as described in step 210. This may also include any transmission parameters or statistics from the multicast and/or unicast transmissions from steps 240a and/or 240b. The smart proxy receives the updated network information. An example of this step may be found in step 819 of FIG. 8.

Here in an eleventh step 255, the smart proxy, after receiving a list of missing blocks from each of the plurality of client devices in the network and updated network information from the cellular network decides whether or not to end the session and stop transmission of the data object to the client devices. An example of this step may be found in step 823 of FIG. 8. This may be the result of all or a significant majority of the blocks comprising the data object being missed, or unicast messages reporting missing blocks not being successfully received. This also may result from changes in the network information, such as the channel quality being significantly degraded or a number of the client devices disconnecting from the session or cellular network. Also, in the eleventh step 255, the smart proxy decides whether to transmit the missing blocks to the client device via unicast or multicast or both. In other words, the smart proxy will decide to transmit the one or more missing data blocks to the clients via unicast or multicast or both multicast and unicast or cease transmission completely for the missing data block. The smart proxy may also end further transmission of data blocks in the data object. The decision may be based on the number of unsuccessful transmissions of the missing data block within the one or more transmission windows. The smart proxy may use the gathered network information to decide to transmit the missing data block to the client device via unicast and/or multicast. This decision may be based on the information gathered in steps 245 and optionally in step 250 and is described in more detail in method 300. This decision allows for the increase in efficiency of retransmission and potentially decreasing the number of packets sent over the communication network, thereby reducing the network resources used. This together with the lower overhead of the CoAP protocol compared with other application protocols, RESTful or otherwise, allows for the reduction of network resources when transmitting large data objects to many devices such as in firmware updating. Additionally, the multicast repair may also reduce the time needed to transmit large data objects when in comparison to a sequential unicast to each device missing data blocks, particularly in cases where there are many devices missing similar blocks.

This decision informs the transmission configuration, and the smart proxy may then proceed with indicating a new transmission configuration to the cellular network. This may be done in step 260 with the initiation of transmission of one or more missing data blocks according to the decision or may be done prior in a separate transmission. The transmission configuration may be to transmit the missing blocks to at least one of the plurality of client devices, that did not successfully receive all blocks of the data object, via unicast, multicast or, a mixture of both or cease transmission and report failure. An example of this transmission configuration is that the first data block is unicast to some or all client devices while the second data block is multicast to half of the client devices and the third is both multicast to the same client devices and unicast to the different client devices to ensure successful transmission. This update of the transmission configuration may in some embodiments be done by updating the session.

The smart proxy will then, in a twelfth step 260, initiate a transmission of one or more of the missing data blocks according to the decision in step 255. This may be via multicast, in step 260a or unicast, in step 260b, or both multicast and unicast based on the transmission configuration in the session, of the missing data blocks to a plurality of client devices. An example of this step may be found in 817, 824 and 825 of FIG. 8.

The system may then loop back to step 240, with the client devices tracking which blocks are received by the transmissions in step 260, moving through steps 245 to 260 and then repeating the loop, until, in a thirteenth step 265, the client device indicates that it has received all transmitted blocks, or one or more transmission windows expire. The expiration of the windows would lead the smart proxy to determine that the transmission is a failure and abandons further transmissions to either one or a plurality of the client devices missing blocks such as was done in step 255. An example of this step may be found in steps 820 and 827 of FIG. 8.

The decision to cease transmission of the missing data block may be based on, the data block being missed by the client device in one or more of the associated transmission windows and/or the gathered network information. This determination is made by considering a variety of factors. An example of these factors may be the number of blocks of the data object missing per client device, the number of client devices in the communication network, the quality of the radio channel between client devices, any network devices between the client device, application server, and the smart proxy, any excess capacity in various control channels in the network, and/or the mobility of the client devices.

Once the smart proxy has ceased transmission either due to success or failure, the smart proxy, in a fourteenth step 270, will proceed to release the session with the cellular network and by extension to the client devices. In the current embodiment, the smart proxy ends the communication of the data object once the finalization phase has elapsed. The smart proxy does this by initiating the release of the session for the one or more client devices once the finalization phase of the one or more client devices and also belonging to the session has elapsed. An example of this step may be found in step 833 of FIG. 8. Then, in a fifteenth step 275, the smart proxy will report to the application server, the status of the transmission being a success or a failure for each client device in the one or plurality of client devices and possibly the magnitude of failure in terms of missed blocks or the number of retries necessary to succeed in transmission. An example of this may be found in steps 835 and 839 of FIG. 8.

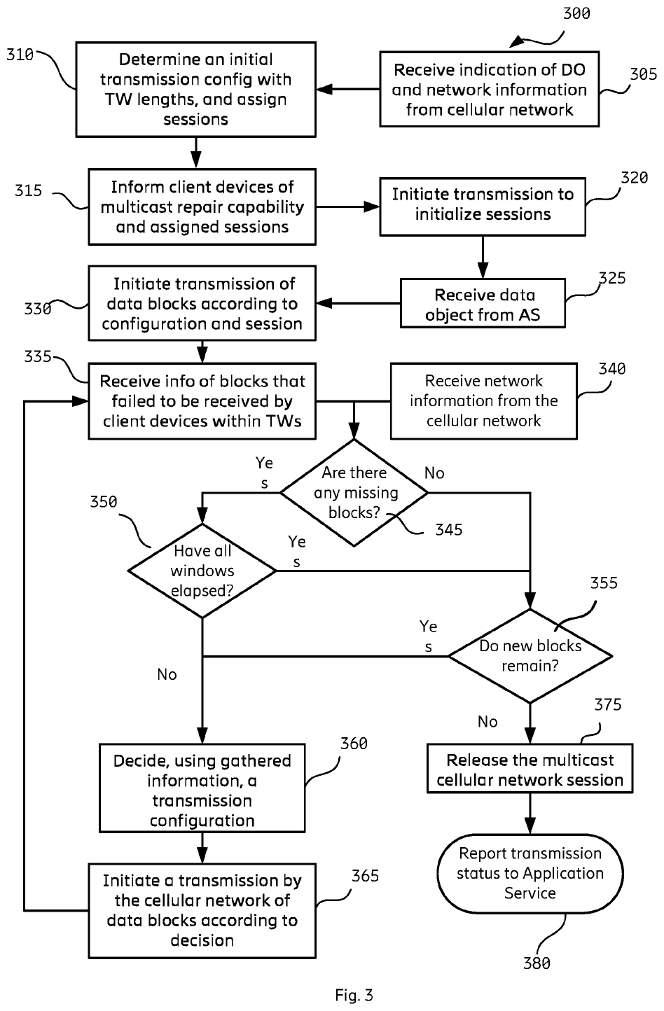

FIG. 3 illustrates a flowchart showing an example of a method 300 performed by a network device 120, referred to as a smart proxy, for the decrease of the use radio resources in a radio network 100 for large data transfers between an application server 130 and a plurality of client devices 110 while using the CoAP protocol. These steps may be complementary to those shown in the signaling diagram of FIG. 2. These radio resources may be but are not limited to time on air, power usage, network bandwidth or any combination thereof.

In FIG. 3 and method 300, the smart proxy begins with a first step 305 by receiving an indication of a data object, DO, suitable for multicast and ready to be transmitted to a group of client devices from one or more application servers. The smart proxy also receives the network information from the cellular network. This information may include but is not limited to the number of client devices marked for reception of the data object either by unicast or multicast, mobility characteristics from at least one of the plurality of client devices, the cell conditions such as the number of devices, radio resource allocation, network resource allocation, available bandwidth, received signal strength and reliability of recent communications exchanges and radio parameters for each client device, such as power usage modes and coverage extension levels. This information may also include a number of client devices in which the data object is to be communicated to; a number of client devices belonging to a cell; radio resource allocation of a cell; network resource allocation for a cell; available bandwidth in a cell; and/or, at least one radio parameter, derived from the reference and sounding channels, for each client device. indicating to the cellular network and, by extension the client devices, that it may be able to assist the application server in providing the capability to retransmit blocks missed during a potential transmission of a data object.

In a second step 310, may then decide to initially, which, in other words, would be the first instance of transmission of the data blocks of the data object, transmit data objects to the client device via multicast or unicast in blocks containing parts of the data object using the gathered network information. This decision is used to determine an initial transmission configuration. This decision may be based on the number of unsuccessful transmissions of the missing data block within one or more transmission windows, the number of unsuccessful transmissions derived from a previous transmission of the data object or similar. This decision may also be based on the number of missed data blocks of the data object per client device of the client devices from a previous transmission of the data object or similar. This decision may be made using a default setting or by using the information to influence an optimization algorithm. This decision may also group client devices together in different multicast groups and individual unicast client devices. These groups and individual client devices differ by, for example, which blocks are sent, the network settings and/or the transmission settings. These network settings could include for example, the coverage extension levels, power usage modes, and/or mobility characteristics. The transmissions settings may include for example, the transmission power, the bandwidth used, and/or the repetitions of blocks sent.

An example of the determining of initial transmission configuration may be that the smart proxy makes the decision that if a client device is in the most extreme coverage extension level, the smart proxy will always recommend a secondary unicast transmission to that client device directly following the multicast transmission in order to add a level of redundancy so as to increase the reliability of the transmission. Another example may be that the smart proxy switches a client device to a different application server's multicast transmission if the mobility characteristics change is such a way that the new application server's multicast transmission will have a better reliability. Yet another example of this determination would be that the smart proxy takes the sleep pattern or other power usage mode of the client devices into consideration. Given that the client devices are likely IoT or other low capability devices, the client device may be in sleep mode when a data object may be transmitted. A client device in sleep mode would therefore miss any unicast or multicast transmission sent by the application server. The smart proxy may, to avoid this, then create several multicast sessions that group client devices into, for example 3 different groups, so that the client devices can both receive the initial multicast transmission at a time when all client devices in each group are awake and can then receive a subsequent multicast retransmission at a time when all client devices in each group are awake again at a later time.

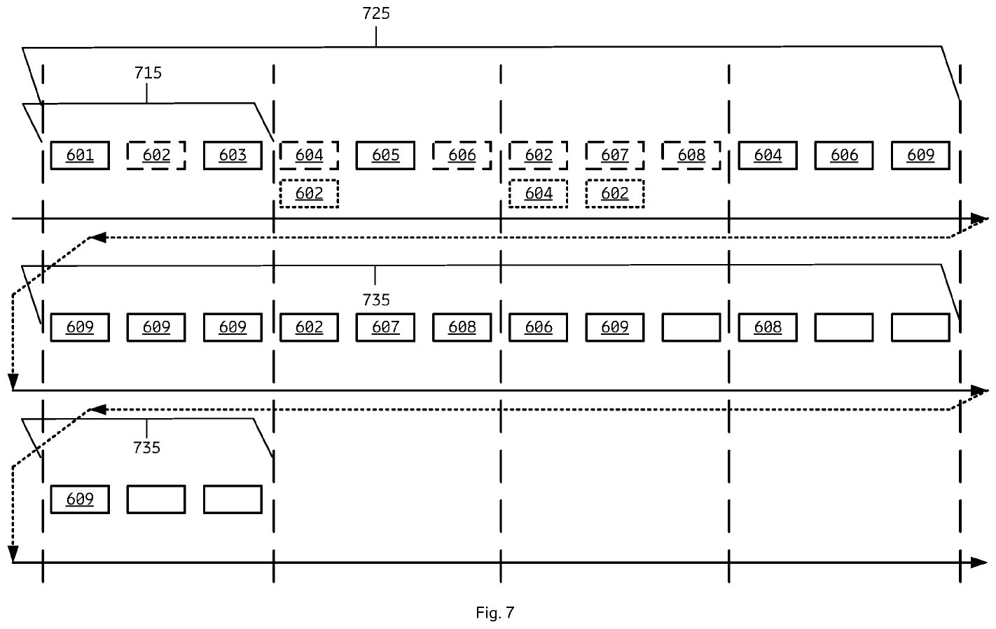

The smart proxy may also determine the one or more lengths for transmission windows corresponding to a data block of the data object associated with client device as a part of the initial transmission configuration. The transmission windows may be or comprise the retransmission window 715, the correction window 725 and the finalization phase 735 or a mixture of all three. These windows are described in more detail in FIG. 7. This is done through the use of the information received in step 305. In another embodiment, the client devices already have a preset values for a retransmission window, a correction window, and a finalization phase. In another embodiment, the client devices have multiple preset values for one or a plurality of windows and the smart proxy may designate which preset values to use. The one or more lengths of the one or more transmission windows may be defined by a number of blocks, number of data blocks, or a length of time. The determining of the length of transmission windows of a session may be based on the number of missing blocks in one or a plurality of the transmission windows from a previous multicast or unicast session to which the client device was previously assigned, the number of data blocks in the data object, the number of client devices in the session and/or associated with the transmission windows, and/or the gathered network information.

An example of the determining of the window lengths for both the retransmission window and the correction window may be that the smart proxy extends these window lengths if the number of users exceeds a predetermined number and expand this window by half for every doubling of devices to allow for the application server time to resend missing blocks to all possible devices. Another example may be that the smart proxy sets short window lengths of three blocks and nine blocks respectively when the client devices are far away or in poor coverage as the expectation may be that the client devices will fail transmission and that the application server should switch to a more reliable high power unicast transmission quickly in the event of failure or report a complete failure and avoid unnecessary transmissions of the data object. An example of the determining of the window length for the finalization phase may be that the correction window was particularly long necessitating the need for a long finalization period.

The initial transmission configuration may comprise the information detailing the multicast or unicast session comprising one or more or all of the client devices that are to receive the data object from the application server. The client devices would be assigned to a session whereby the session would comprise a start time, an indication of multicast repair functionality and information indicative of the length of the transmission windows of the client devices belonging to the session. The initial transmission configuration may also comprise the information for multiple multicast and or unicast sessions for groups of client devices that are to receive the data object from the application server. client devices would be assigned to one or more of the multicast sessions, the unicast sessions or both the multicast sessions and unicast sessions based on network information or the number of the missed blocks in one or a plurality of the transmission windows per client device. The different assigned sessions would differ by which blocks are to be transmitted in the session, when the blocks are transmitted, the transmission window lengths, the network settings, and/or transmission settings.

In a third step 315, the smart proxy may inform, through the cellular network, the client devices of a multicast repair capability and assign the client devices to one or more of the sessions. This would be done by the smart proxy initiating transmission of information indicative of one or more sessions assigned to the client device and/or initiating transmission of information for initialization of one or more sessions. The smart proxy may also intimate transmission of information indicative of one or more transmission windows and/or the lengths of the one or more transmission windows.

The smart proxy, in a fourth step 320, initiates the transmission of and transmits information for initialization of the one or more sessions to the cellular network and onward to the client devices.

The smart proxy, in a fifth step 325, receives the data object from the application server. In other embodiments, the smart proxy may receive the data object in single or groups of data blocks during transmission to the client devices. Alternatively, the smart proxy may also receive the data object from some other storage medium connected to the smart proxy through the network

The smart proxy, in a sixth step 330, will initiate transmission to the cellular network, data blocks for transmission to the client devices in the network according to the transmission configuration of the session.

The smart proxy may, in a seventh step 335, the smart proxy will receive a list of blocks that failed to be received by client devices via the cellular network. In other words, the smart proxy will receive at least one indication of at least one missing data block from a client device of the client devices that did not successfully receive all data blocks of the data object within at least one transmission window of an earlier transmission in the communication associated with the client device.

The smart proxy may in an eighth step 340, also receive updated network information from the application server with updated information of the same nature as in step 305. This network information may be updated with information gathered from other network transmissions and/or the multicast transmission initiated at step 330.

The smart proxy, in a ninth step 345, check if there are any blocks that the client devices are still missing from the transmission.

The smart proxy may also, if there are window used then, in a tenth step 350, check if the correction or, if used, the finalization phase has elapsed. and if so, end the communication of the data object. If there are no missing blocks or all windows have elapsed, the smart proxy may also in an eleventh step 355, check if there are any new, previously not yet transmitted blocks, of the data object that have yet to be sent to the client devices. If there are no missing blocks, or the windows have elapsed, and there are no further new blocks to transmit, the smart proxy will move to step 375. If, however, there are missing blocks and the windows have not elapsed, or there remain new blocks to transmit, the smart proxy may move to step 360 or in other embodiments, move straight to step 375 if the received network information indicated a poor transmission environment or other issues necessitating termination of transmission.

In a twelfth step 360, the smart proxy will decide to transmit the one or more missing data blocks to the client device via unicast or multicast or both unicast and multicast. This may also be described as determining a transmission configuration by deciding to transmit the missing blocks to each client device via multicast or unicast or both. The smart proxy may use the gathered information, such as the gather network information, from steps 315, 355 and possibly 360 to make the decision. The decision may also be based on the number of unsuccessful transmissions of the missing data block within the one or more transmission windows and/or per data object per client devices of the client devices. This determination may be made using a default setting or by using the information to influence an optimization algorithm. This determination may also group client devices together in different multicast groups and individual unicast client devices on a per data block basis. These groups and individual client devices differ by, for example, which blocks are sent, the network settings and/or the transmission settings. These network settings could include for example, the coverage extension levels, power usage modes, and/or mobility characteristics. The transmissions settings may include for example, the transmission power, the bandwidth used, and/or the repetitions of blocks sent.

An example of this determination would be that client devices that share missing blocks are given a multicast retransmission and client devices that alone have a missing data block receive a unicast transmission. For instance, when only one of the plurality of client devices, client device A, misses data block 3 of 5 total transmitted and 3, client devices C, D, and E, of the plurality of client devices all miss data block 4 of 5 total transmitted, the smart proxy transmits data block 3 via unicast to client device A since no other client device was missing data block 3 and multicast data block 4 since client devices C, D, and E all share the common missing data block.

Another example of this determination would be that if multiple contiguous blocks are missed by a significant majority of the plurality of client devices, the smart proxy will determine that that blocks will be multicast to all client devices based on the likelihood that client devices indicating successful transmission may have received a corrupted data block or no data block at all given the poor performance of the initial transmission and client devices in the outermost coverage extension level may additionally receive a unicast transmission acting as a type of redundancy ensuring successful reception.

Another example of this determination may be to abandon the session entirely due to poor transmission conditions, such as abnormally high pathloss, as shown by the collected network data. This would spur smart proxy to inform the application server of failure and may initiate a new session or multiple new sessions from step 320 and begin the process over with a new session and window lengths that suit the network conditions.

In making the determination of which transmission method to use in sending missing data blocks to client devices, the smart proxy may also use a variety of optimization algorithms which are widely utilized in the state of the art which may include but are not limited to, multi-objective programming, vector optimization, multicriteria optimization, multi-attribute optimization or pareto optimization. These could make use of the inputs described above help make a determination.

In another embodiment, the smart proxy may also decide to determine the length of transmission windows of the session, the determining being of the length of transmission windows of a session may be based on the number of missing blocks in one or a plurality of the transmission windows from a previous multicast or unicast session to which the client device was previously assigned, the number of data blocks in the data object, the number of client devices in the session and/or associated with the transmission windows, and/or the gathered network information.

Once the transmission configuration is determined, the session or sessions will be updated accordingly.

Once the smart proxy has determined a transmission configuration, the cellular network then, in a thirteenth step 365, is initiated by the smart proxy to transmit one or more of the missing data blocks via multicast, unicast, or not at all according to the decision/transmission configuration in step 360 and subsequent update to the session made in step 360. The smart proxy will then return to step 345 and loop around again until the method reaches step 375.

The smart proxy will, in a fourteenth step 375, the smart proxy then initiates the release and releases the session for the client device. This may be done once the finalization phase of the client device and belonging to the session has elapsed. In a final fifteenth step 380, reports the transmission status to the application server. The transmission status may contain information indicative of a successful transmission or a transmission failure on a per client device and per data block basis. For example, the status may indicate that data block 4 of 5 needed to be retransmitted 3 times to a certain client device before successful reception of the data block. This information may allow for an improved transmission of large data objects for future multicast session setups.

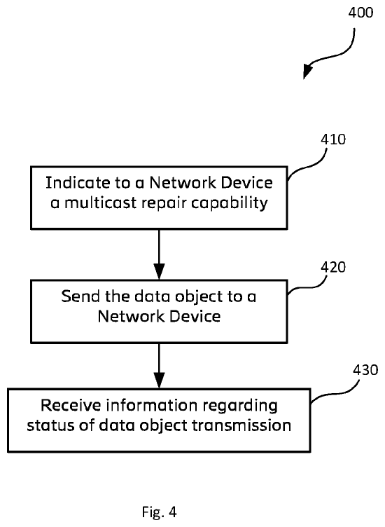

FIG. 4 illustrates a flowchart showing an example of method 400 performed by an application server 130 during the transfer of the data object using CoAP as in the present disclosure. The steps of method 400 may be complementary to those shown in the signaling diagram of FIG. 2 and the steps of method described in 300. The application server may be a network device.

In FIG. 4 and method 400, the application server begins with a first step 410 by communicating to the network device 120 referred to as the smart proxy and by extension the client device that the application server has the capability to retransmit blocks missed during a potential transmission of a data object. In the present embodiment, this is done by providing a uniform resource locator (URL) at the application server and to the smart proxy where requests for missing blocks may be received.

The application server, in a second step 420, sends the data object to the smart proxy for later transmission to the client devices.

The application server, in a third step 430, receives information regarding the status of the transmission of the data object from the smart proxy for each multicast session created and which client devices that successfully received the data object, partially received the data object or that failed to receive the data object in each session. In the present embodiment, this is done towards the URL defined by the application server in step 410 for transmission of the data object.

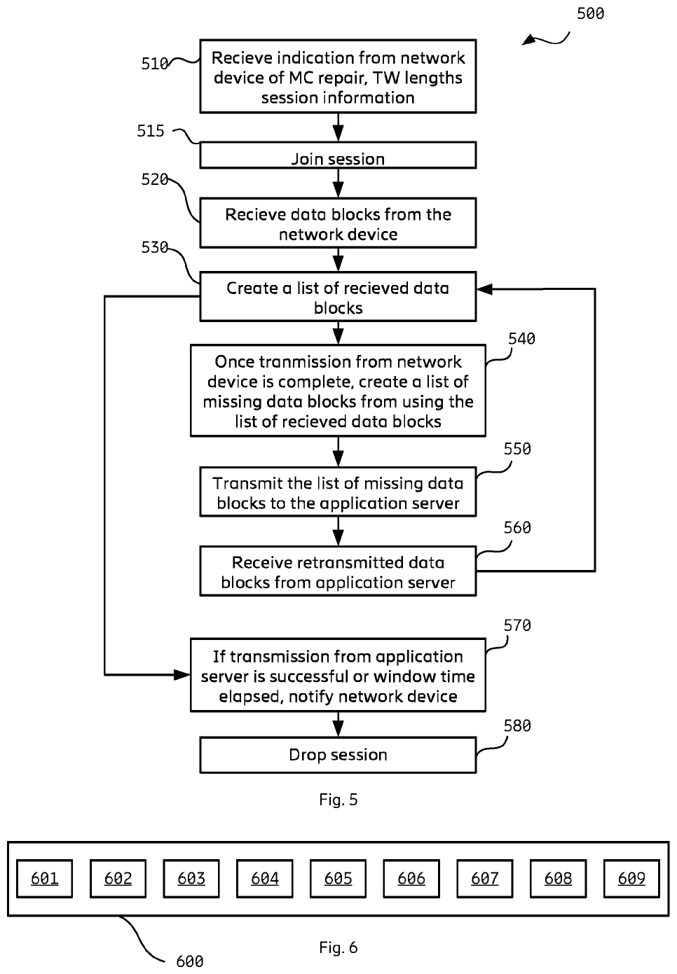

FIG. 5 illustrates a flowchart showing an example of method 500 performed by a client device during the transfer of the data object using CoAP as in the present disclosure. The steps of method 300 may complement the steps of method 500 enabling a plurality of client devices to communicate with the smart proxy in the manner described in method 300. The client devices may be network devices or endpoint devices.

In FIG. 5 and method 500, in the first step 510, the client device receives an indication from the application server that the application server is capable of multicast repair. This may be received in the form of information related to a session or sessions created for the client device. The client devices receiving the data object will then keep track of the blocks of the data object received from the multicast transmission. As a part of the session information, the client device may also receive transmission window lengths. The transmission window lengths may comprise one of or a combination of the retransmission window 715, the correction window 725 and/or the finalization phase 735.

In a second step 515, the client device may join the session at a time defined by the session.

In a third step 520, the client device then receives data blocks transmitted from the smart proxy and subsequently, in a fourth step 530, will create a list of received data blocks.

In a fifth step 540, if any blocks of the data object fail to be received or are received in a corrupted state by the client device, the client device will then detect and record the blocks that are missing by using the list of received data blocks from step 520. The client device will subsequently make a request for these blocks to the smart proxy in a sixth step 550 and in a seventh step 560 receive any retransmitted data blocks from the smart proxy that are transmitted by the cellular network withing the time limit defined by the correction window. The client device then repeats steps 530 through 560 until an eighth step 570, where the transmission is deemed by the client device to be either complete, a failure or, if applicable, the time of the window length for either the correction window or finalization phase has expired and the whole transmission is also deemed a failure and indication of this is sent to the smart proxy. Finally in a ninth step 580, the session is dropped.

FIG. 6 illustrates a diagram illustrating an example of a data object 600 for an embodiment of the present disclosure. The data object comprises 9 data blocks, 601 through 609. In order for the data object to be usable, it must contain all its constituent blocks. In other embodiments, the data object may have duplicate blocks or blocks that serve a diversity or error correcting purpose such as error correcting parity data in the event of a missing data block. Examples of the data object may be a firmware update for the client device. In the current embodiment, this data object is sent using the CoAP block-wise protocol.

FIG. 7 illustrates a diagram illustrating an example of an embodiment of the present disclosure. In FIG. 7, the retransmission window 715, the correction window 725, and a finalization phase 735 are shown along a line with an arrowhead to denote time and the direction of time respectively. Retransmission windows and correction windows may be defined by either a number of transmitted blocks or a set length of time. However, the finalization phase must be a set length of time in the event that blocks are poorly received by the client device, which would allow for the eventual ceasing of the transmission. The network device 120, is referred to as the smart proxy.

The embodiment of FIG. 7 portrays a block-based definition of the lengths where the finalization phase is of a time length equivalent to the time required to transmit a correction window plus a retransmission window. Each vertical dashed line indicates a slot of sufficient length to transmit three data blocks and correspond to the exemplary length of the retransmission window of three data blocks. In some embodiments, a retransmission window may set a random length to the retransmission window where the length is either a range of blocks from 0 to an integer set by smart proxy or a time limit from zero to value set by the smart proxy. The data object 600 is being sent using the CoAP block-wise protocol. Blocks that have a solid outline are blocks successfully received such as blocks 601 and 603. Blocks that have a dashed outline, such as 602 and 604, are blocks that have either been missed or are received but corrupted. Blocks below these that have a dotted outline, such as 602 and 604, are blocks that are requested by the receiver for retransmission and in the current embodiment are to be retransmitted in the following window. In other embodiments, the retransmitted blocks may be retransmitted in later windows rather than the immediate proceeding window or in a dedicated window for retransmission.

The retransmission window 715 begins from the beginning of the transmission of the data object and ends three blocks later with possible added margin. In other embodiments, these retransmission windows may not directly follow one another but instead have a regular or scheduled spacing in-between. In this interval, the client device 110 tracks all blocks received and if a data block, for example data block 602, is missing or corrupted, such as 602 or 604, the client device 110 will notify the proxy server, of a missing or corrupted data block in the second retransmission window after the first retransmission window has expired. The client device also requests a retransmission of the data block missed in this second retransmission window as can be seen for data block 602a. The client device will then wait for the third retransmission window where data block 602b, which is a retransmission of data block 602, is transmitted. The number of these back-and-forth cycles is limited by the correction window 620, which determines when the client device may no longer request retransmission and must instead indicate a failure to receive the packet. The correction window starts from the beginning of the transmission of the data object and ends in this example at a length of 4 retransmission windows later. A correction window should be of a length at least a multiple of the retransmission window. If the client device 110 receives a data block that was missing, such as data block 604c, the transmission of data block 604 is determined to be a success. However, in FIG. 7, the client device still misses data block 602b allowing for the one more request of data block 602, in the form of data block 602c before the passing of the correction window 620. If the client device, then misses data block 602d, the client device will be unable to request a retransmission of data block 602 due to the passing of the correction window and will notify the proxy server, that the client device has failed to receive the data block 602 and therefore the data object in its entirety. In some embodiments, the smart proxy will receive an indication that transmission is a complete failure. In other embodiments, the smart proxy will receive a report indicating which data block was failed to be received and may attempt to transmit the data block as a separate data object at a different multicast or unicast session.

The correction window is crucial since retransmissions may, in certain embodiments, take the space of transmitting new data blocks in the data object and without the correction window, the transmission may never end if all blocks are requested for retransmission. Once all data blocks of the data object have been transmitted at least once, the smart proxy will initiate the finalization phase. This may be done by, for example, transmitting the last data block of the data object, data block 609, at a low frequency repeatedly or transmitting a specialized message or any data block of the data object. In this example, this is three repetitions over the proceeding retransmission window. This notifies the client devices that no new data blocks will be transmitted and only corrections will be handled.

The finalization period allows for all correction windows associated with their respective data blocks to expire and for the smart proxy to retransmit any missing blocks in the occasions allowed for. An example of this would be if data block 609 was consistently missed, whereby the last possible opportunity to receive a retransmission of data block 609 would be in the first slot in the third row. The finalization period therefore should be the length of a correction period plus the extra time for initiating the finalization phase These three windows allow for multicast retransmission function of the embodiment to not take over the network in perpetuity, where the network might otherwise attempt to retransmit missing blocks before the entire data object is received or over and over again until the retransmission is successful which may never happen.

FIG. 8 illustrates a signaling diagram illustrating an embodiment of the present disclosure. The embodiment may correspond to and elaborate in greater detail on portions of the embodiment described in FIG. 2, but the two embodiments should not be considered as necessarily the same embodiment of the present disclosure. The network device 120 is referred to as the smart proxy.

Starting with a first Step 801, the smart proxy receives from the application server (AS) an indication of a Data Object (DO) to be transmitted in data blocks (DB) to the client devices. This is achieved by the smart proxy receiving, a PUT object delivery service URL, comprising the DO reference 800, from the IoT-AS-Object Handler to the Object-Delivery-Service with the payload {Data-Object-Reference, Device-Group-Descriptor}. The smart proxy in a second step 802 accepts the PUT object by informing the AS of the acceptance with the payload {service-request-id} and in step a third 803, the smart proxy receives gathered network information of the Device Group from the cellular network. This information may also include a number of client devices in which the data object is to be communicated to; a number of client devices belonging to a cell; radio resource allocation of a cell; network resource allocation for a cell; available bandwidth in a cell; and/or, at least one radio parameter, derived from the reference and sounding channels, for each client device. indicating to the cellular network and, by extension the client devices, that it may be able to assist the application server in providing the capability to retransmit blocks missed during a potential transmission of a data object.

The smart proxy then in a fourth step 804, decides on the number of multicast (MC) sessions, the characteristics of the multicast sessions and any sub-groups of devices, all based on the gathered network information. This serves to assign the client device to one or more of the multicast sessions, the unicast sessions, or both the multicast sessions and the unicast sessions, the sessions comprising a start time, an indication of multicast repair functionality, and information indicative of the length of the transmission windows of the client devices belonging to the session. The length of the transmission windows of a session may be based on the number of missing blocks in one or a plurality of the transmission windows from a previous multicast or unicast session to which the client device was previously assigned, the number of data blocks in the data object, the number of client devices in the session and/or associated with the transmission windows, and/or the gathered network information. The sessions would be assigned to the sessions based on network information or the number of missed blocks in a plurality of the transmission windows per client device. The session would differ by which blocks are to be transmitted in the session, when the blocks are transmitted, the transmission window lengths, the network settings, and/or transmission settings. The smart proxy as a part of the step also determines the one or more transmission windows corresponding to a data block of the data object associated with the client device. The smart proxy also determines the one or more lengths of the one or more transmission windows, the one or more lengths being defined by a number of locks or length of time.

The smart proxy initiates transmission of information indicative of one or more sessions assigned to the one or more client devices by unicasting (UC) to each client device, in a fifth step 805, when the client device is reachable the next time along with communicating details about the multicast session being defined with the example message:

CoAP.REQ:PUT multicast-session-object-id {session parameters:
-session start time
-retransmission-service-URL
-retransmission window size
-correction window factor
-finalization phase size
-...}

This serves to initiate the transmission of information indicative of one or more transmission windows and/or the lengths of the one or more transmission windows. Where the session start time is when the multicast transmission is supposed to begin, the retransmission service URL is the URL that the client devices will send a list of missing packets too, the retransmission window size defines the size of the retransmission window (RW), the correction window (CW) factor defines the size of the correction window will be in terms of retransmission windows, the finalization phase (FP) size defines the size of the of the finalization phase, and the ellipses encompasses any other necessary parameters to fully define the multicast session of the client device. These details serve to inform the client device of a multicast repair functionality enabled by the smart proxy. In a sixth step 806, the client devices will store the session info from the CoAP.REQ: PUT message in step 805 and being a wakeup timer for the multicast session, so that the client device will join the session and listen for transmissions at the appropriate time. Once this is complete, the client device, in a seventh step 807, will acknowledge the successful set up of the session with the message, CoAP.ACK: 800 OK. The smart proxy will then, in an eighth step 808, request the data object, DO, from the application server with the message, GET Data-Object-Reference to which the application server, in a ninth step 809, will send 800 OK {Data Object} containing the DO. The smart proxy will then store the DO in a tenth step 810.

From here, steps 811 to 834 will loop once for each multicast session as determined by the smart proxy in step 804. The steps for a single loop describing a single multicast session will be described in detail. Embodiments will comprise multiple loops for multiple multicast sessions. In an eleventh step 811, the multicast session wakeup timer for the client devices will expire and the client devices will become ready to receive data associated with the data object. The smart proxy then, in a twelfth step 812, will initiate the transmission of information for initialization of one or more sessions, the information being the multicast session with the predetermined parameters from step 804 by sending a message to the cellular network with the parameters. In a thirteenth step 813, the cellular network will receive the initialization message and establish the multicast session for the smart proxy, the cellular network, and the client devices. Then in a fourteenth step 814, which repeats for each client device, the client devices will join the multicast session.

Now all is set to start transmission of the data object and in a fifteenth step 815, the smart proxy will multicast data blocks in the first retransmission window. This is done according to the format used in standard RFC 7959 using the Block1/2 format in the current embodiment. However, alternative methods of multicasting and unicasting data blocks according to the CoAP standards should be readily apparent to the skilled person. One such alternative would be CoAP with Quick-Block1 as proposed by the IETF memo, draft-ietf-core-new-block-01. The client device devices will then, in a sixteenth step 816, collect a list of missing data blocks from this first multicast transmission. This begins a loop from the second to the final retransmission window inside the correction window for steps 817 to steps 827. Some of these steps in the loop are dependent are certain criteria so all steps and their corresponding criteria will be as described over the course the first loop for steps 817 to 823 and the last loop for steps 824 to 826.

A seventeenth step 817 and eighteenth step 818 are triggered if there are missing data blocks from a previous retransmission window recorded by the client devices. In step 817, the smart proxy receives a unicast report of missing data blocks from the client devices with the message CoAP.REQ: PUT Retransmission-Service-URL {list of missing blocks}. This unicast report comprises at least one indication of at least one missing data block from a client device of the client devices that did not successfully receive all data blocks of the data object within at least one transmission window of an earlier transmission in the communication associated with the client device. Then in step 818, the smart proxy sends an acknowledgement to the client devices with the message CoAP.ACK: 800 OK.

In the embodiment where the smart proxy has the ability to preemptively close the sessions based on network information, a nineteenth step 819 and a twentieth step 820 are performed. The smart proxy receives gathered network information of the same character as the network information gathered in step 803 but updated to be as current as possible. The smart proxy then, in step 820, closes the current multicast session if it is determined that the network information indicates unfavorable network conditions for further transmission such as client devices disconnecting from the network, the channel conditions becoming sufficiently poor, or the number of unsuccessful transmissions of the missing data blocks with the one or more transmission windows.

A twenty-first step 821, a twenty-second step 822, and a twenty-third step 823 are always run in the loop in the embodiment of the invention where there is a dedicated space for retransmission of missing data blocks of previous transmissions. If the number of blocks comprising the data object is smaller than the length of the correction window, these steps are skipped. In step 821, the smart proxy multicasts the latest data blocks of the data object. In step 821, the client devices collate a list of any missing data blocks from the multicast in in step 819. Then in step 823, the smart proxy decides to transmit the one or more missing data blocks as recorded from step 817 to the client device via unicast, multicast or both unicast and multicast. This decision may be based on the number of unsuccessful transmissions of one or more of the missing data blocks within the one or more transmission windows. This decision may also be based on the number of missed data blocks of the data object per client device of the client devices. The smart proxy may also make the decision using the gathered network information.

A twenty-fourth step 824 and a twenty-fifth step 825 are triggered if there are missing data blocks from the previous retransmission windows within the correction window. In step 824, the smart proxy multicast transmits the one or more missing data blocks to the client according to decision and thereby to the multicast session and all client devices belonging to it. In step 825, the smart proxy transmits one or more missing data blocks via unicast according to the decision made in step 823. To transmit missing data blocks to select client devices via unicast is dependent on if there was a limited number of client devices who missed the data block, if there was a need for a more reliable unicast transmission, or if there was a need for diversity of transmission for a data block to a client device. Examples of this decision may be found in method 200.

In the event of a successful retransmission of missing data blocks to a client device from the smart proxy through the cellular network, a twenty-sixth step 826 has the client device repair any incomplete data block ranges in the data object with the missing data blocks. The client device may also repair any individual missing blocks if the retransmission of a missing data block was able to successful transmit enough data to repair the missing data block.

Steps 827 through 830 are triggered if there are still missing or corrupted data blocks after the correction window for the missing or corrupted blocks has passed. In a twenty-seventh step 827, the smart proxy may receive an optional report of the data object compilation failure in the form of the message CoAP.REQ: PUT Retransmission-Service-URL {ERROR: object compilation failure}. Then in a twenty-eighth step 828, the smart proxy stores the ID of any client devices that reported an object complication failure indicating that not all blocks where received. In a twenty-nine step 829, the smart proxy transmits an acknowledgement to the client devices in form of the message CoAP.ACK: 800 OK. The client devices then, in a thirtieth step 830, stops object download and proceeds to leave the multicast session.

Once the final data block in the data object has been transmitted, the finalization phase begins. This allows for the remain blocks to finish their respective correction windows and inform the client devices that no new blocks are being transmitted. The beginning of this phase begins with a thirty-first step 831 and a thirty-second step 832. In step 831, the smart proxy multicasts the last data block of the data object at a low frequency to signify the end of the data object and the beginning of the finalization phase. In step 832, the client devices recognize the finalization phase from the low data throughput and prepare to strictly receive and repair already transmitted blocks. From here, the steps of 817 through 830 repeats for the data blocks with a ‘correction window’ time remaining in the finalization phase. The retransmission windows in this phase are called finalization windows. This means that the finalization phase consists of n plus one finalization windows, where n is the length of the correction window.

Once the finalization phase is complete, the smart proxy, in a thirty-third step 833, initiates the release of the session for the one or more client devices. This is done once the finalization phase of the client device and belonging to the session has elapsed. This is done by transmitting a message to the cellular network comprising an indication to end the current multicast session. In other words, the smart proxy ends the communication of the data object once the finalization phase has elapsed. The cellular network, after receiving the indication will proceed, in a thirty-fourth step 834, to release the smart proxy and any still connected client devices from the multicast session. The smart proxy then, in a thirty fifth step 835, sends a PUT object delivery service URL (800) message to the application server from the Object-Delivery-Service to the IoT-AS-Object Handler with the payload {Error Report: list of failed client devices}. The application server then, in a thirty-sixth step 836, proceeds to store a list of all failed client devices for the multicast session for further processing, which may include scheduling future transmissions of the data object. Then to end of the loop for the specific multicast session started at step 811, the smart proxy, in a thirty-seventh step 837, receives an acknowledgement message in the form of 800 OK.

Once all multicast sessions have been completed, the smart proxy, in a thirty eighth step 838, deletes the data object acquired from the application server and stored in step 810. In a thirty-ninth step 839, the smart proxy sends a PUT IoT-AS-Object-Handler URL message from Object-Delivery Service to IoT-AS-Object Handler with the payload {Request=Service-request-id performed successfully or performed with exceptions or failed (error-description)} which is a report on how the transmission of the data object performed. The method finishes with a final fortieth step 840, where the smart proxy receives an acknowledgement from the application server that it received the performance report sent in step 839.

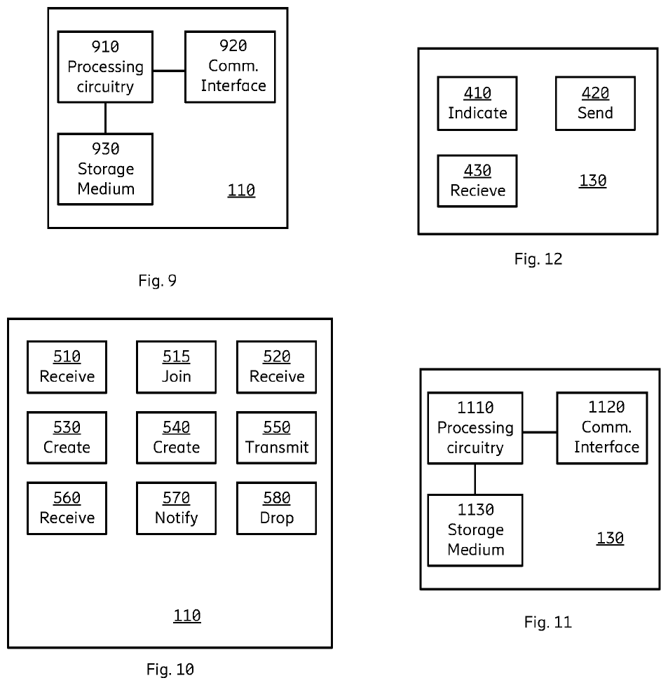

FIG. 9 is a block diagram of an application server 130 according to some embodiments. As shown in FIG. 9, the application server 130 may comprise: processing circuitry 810 which may include one or more processors (e.g., a general purpose microprocessor and/or one or more processors, such as an application specific integrated circuit (ASIC), field-programmable gate arrays (FPGAs) and the like); a communications interface 820 for communicating with other devices connected to a network 100; and a storage medium 830 which may include one or more non-volatile storage devices and/or one or more volatile storage devices (e.g., random access memory (RAM)). In embodiments where the application server includes processing circuitry, a computer program product may be provided. A computer program product 1510 includes a computer readable medium 1520 such as, but not limited to, the storage medium, magnetic media (e.g., a hard disk), optical media, memory devices, and the like. The storage medium may contain a computer program 1530a containing computer readable instructions 1540a that when executed by the processor circuit causes the processor circuit to perform operations according to embodiments disclosed herein. According to other embodiments, processor circuitry may be defined to include a storage medium, so a separate storage medium is not required.

FIG. 10. is a diagram showing functional units of an application server 130 according to some embodiments. As shown in FIG. 9, the application server comprises a number of functional modules; an indicate module configured to perform step 410; a send module configured to perform step 420; and a receive module configured to perform step 330. In general terms, each functional module may be implemented in hardware or in software. Preferably, one or more or all functional modules may be implemented by the processing circuitry, possibly in cooperation with the communications interface and/or the storage medium. The processing circuitry may thus be arranged to, from the storage medium, fetch instructions, thereby performing any steps of the application server 130 as disclosed herein.

FIG. 11. is a block diagram of a client device 110 according to some embodiments. As shown in FIG. 11, the client device 110 may comprise: processing circuitry 1110 which may include one or more processors (e.g., a general purpose microprocessor and/or one or more processors, such as an application specific integrated circuit (ASIC), field-programmable gate arrays (FPGAs) and the like); a communications interface 1120 for communicating with other devices connected to a network 100; and a storage medium 1130 which may include one or more non-volatile storage devices and/or one or more volatile storage devices (e.g., random access memory (RAM)). In embodiments where the client device includes a programmable processor, a computer program product may be provided. A computer program product 1510 includes a computer readable medium 1520 such as, but not limited to, the storage medium 1130, magnetic media (e.g., a hard disk), optical media, memory devices, and the like. The storage medium may contain a computer program 1530b containing computer readable instructions 1540b that when executed by the processor circuit 1110 causes the processor circuit to perform operations according to embodiments disclosed herein. According to other embodiments, processor circuitry 1110 may be defined to include a storage medium so a separate storage medium is not required.

FIG. 12. is a diagram showing functional units of a client device 110 according to some embodiments. As shown in FIG. 12, the client device comprises a number of functional modules; a receive module configured to perform step 510; a join module configured to perform step 515; a receive module configured to perform step 520; a create module configured to perform step 530; a create module configured to perform step 540; a transmit module configured to perform step 550; a receive module configured to perform step 560; a notify module configured to perform the steps 570; and a drop module configured to perform the steps 580. In general terms, each functional module may be implemented in hardware or in software. Preferably, one or more or all functional modules may be implemented by the processing circuitry, possibly in cooperation with the communications interface and/or the storage medium. The processing circuitry may thus be arranged to, from the storage medium, fetch instructions, thereby performing any steps of the client device 110 as disclosed herein.

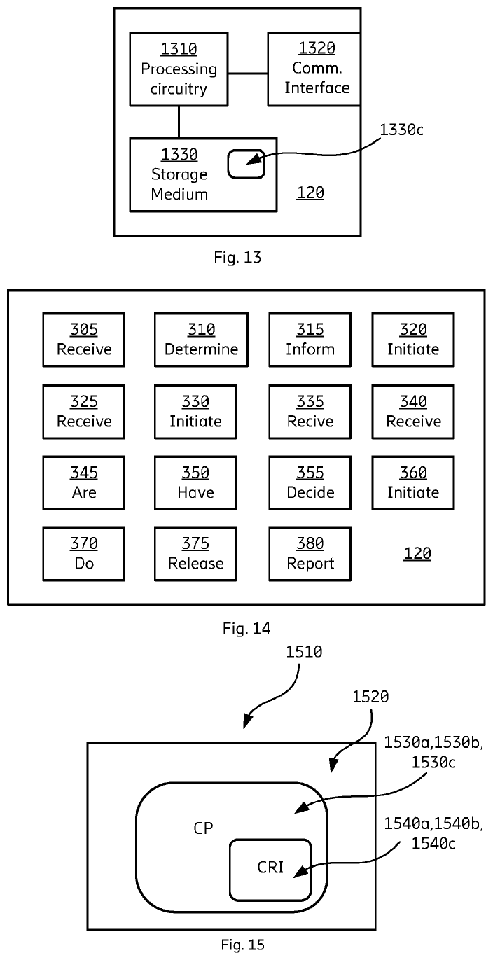

FIG. 13. is a block diagram of the network device 120 according to some embodiments. As shown in FIG. 13, the smart proxy 120 may comprise: processing circuitry 1310 which may include one or more processors (e.g., a general purpose microprocessor and/or one or more processors, such as an application specific integrated circuit (ASIC), field-programmable gate arrays (FPGAs) and the like); a communications interface 1320 for communicating with other devices connected to a network 100; and a storage medium 1330 which may include one or more non-volatile storage devices and/or one or more volatile storage devices (e.g., random access memory (RAM)). In embodiments where the network device includes a programmable processor 1310, a computer program product may be provided. A computer program product includes a computer readable medium 1520 such as, but not limited to, the storage medium 1330, magnetic media (e.g., a hard disk), optical media, memory devices, and the like. The storage medium may contain a computer program 1530c containing computer readable instructions 1540c that when executed by the processor circuit 1310 causes the processor circuit to perform operations according to embodiments disclosed herein. According to other embodiments, processor circuitry 1310 may be defined to include a storage medium so a separate storage medium is not required.

FIG. 14. is a diagram showing functional units of a network device 120 according to some embodiments. As shown in FIG. 14, the client device comprises a number of functional modules; a receive module configured to perform step 305; a determine module configured to perform step 310; an inform module configured to perform step 315; an initiate module configured to perform step 320; a receive module configured to perform step 325; an initiate module configured to perform step 330; a receive module configured to perform step 335; a receive module configured to perform step 340; an are module configured to perform step 345; a have module configured to perform step 350; a decide module configured to perform step 355; an initiate module configured to perform step 360; a do module configured to perform step 370; a release module configured to perform step 375; and a report module configured to perform step 380. In general terms, each functional module may be implemented in hardware or in software. Preferably, one or more or all functional modules may be implemented by the processing circuitry, possibly in cooperation with the communications interface and/or the storage medium. The processing circuitry may thus be arranged to, from the storage medium, fetch instructions, thereby performing any steps of the network device 120 as disclosed herein.

FIG. 15 is a diagram showing an embodiment of the invention. As shown in FIG. 15, the computer program product 1510 comprises a computer readable medium 1520 storing a computer program 1530a, 1530b, 1530c comprising computer readable instructions 1540a, 1540b, 1540c. The computer readable medium may be but not limited to, a storage medium 930, 1130, 1330, magnetic media (e.g., a hard disk), optical media, memory devices (e.g., random access memory, flash memory) and the like.

Also, while various embodiments of the present disclosure are described herein, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A network device for use in a communication network and configured to assist an application server using a Constrained Application Protocol (CoAP) in a communication of a data object to client devices, wherein the data object comprises data blocks, the network device comprising:
processor circuitry; and
a storage unit storing instructions which when executed by the processor circuitry causes the network device to become operative to:
inform the client devices of a multicast repair functionality enabled by the network device;
receive at least one indication of at least one missing data block from a client device of the client devices that did not successfully receive all data blocks of the data object within at least one transmission window of an earlier transmission in the communication associated with the client device and the transmission window or one of the transmission windows is or comprises a finalization phase;
decide to transmit the one or more missing data blocks to the client device via unicast or multicast or both unicast and multicast;
initiate a transmission of the one or more missing data blocks according to the decision; and
end the communication of the data object once the finalization phase has elapsed.

2. The network device of claim 1, wherein the instructions when executed by the processor circuitry cause the network device to become operative to:
determine the one or more transmission windows corresponding to a data block of the data object associated with the client device, the transmission windows being or comprising:
a retransmission window that defines how long the client device should wait to receive one or more missing data blocks before indicating that the one or more data blocks have been missed;
a correction window that defines how long the client device should wait after communicating that the one or more missing data blocks are missing before reporting an error in the communication of the one or more data blocks; and/or
the finalization phase, which defines how long the communication should remain open.

3. (canceled)

4. The network device of claim 1, wherein the instructions when executed by the processor circuitry cause the network device to become operative to:
initiate transmission of information indicative of one or more transmission windows and/or the lengths of the one or more transmission windows.

5. The network device of claim 1, wherein the instructions when executed by the processor circuitry cause the network device to become operative to:
determine the one or more lengths of the one or more transmission windows, the one or more lengths being defined by a number of data blocks or a length of time.

6. The network device of claim 1, wherein the instructions when executed by the processor circuitry cause the network device to become operative to:
decide to transmit the missing data block to the client device via unicast or multicast or both unicast and multicast based on the number of unsuccessful transmissions of the missing data block within the one or more transmission windows.

7. The network device of claim 1, wherein the instructions when executed by the processor circuitry cause the network device to become operative to:
decide to transmit the missing data block to the client device via unicast or multicast or both unicast and multicast using the number of missed data blocks of the data object per client device of the client devices.

8. The network device of claim 1, the network device further comprising
connections for assisting multiple application servers in communicating with multiple groups of client devices for the purpose of multicast and unicast transmissions.

9. The network device of claim 1, the instructions when executed by the processor circuitry cause the network device to become operative to gather network information, the network information comprising:
a number of client devices in which the data object is to be communicated to;
mobility characteristics from at least one of the plurality of clients;
a number of client devices belonging to a cell;
radio resource allocation of a cell;
network resource allocation for a cell;
available bandwidth in a cell; and/or,
at least one radio parameter, derived from the reference and sounding channels, for each client device.

10. The network device of claim 9, wherein the instructions when executed by the processor circuitry cause the network device to become operative to:
assign the client device to one or more of the multicast sessions, the unicast sessions, or both the multicast sessions and the unicast sessions, the sessions comprising:
a start time;
an indication of multicast repair functionality; and
information indicative of the length of the transmission windows of the client devices belonging to the session.

11. The network device of claim 10, wherein the instructions when executed by the processor circuitry cause the network device to become operative to:
assign the client device to one or more of the multicast sessions, the unicast sessions, or both the multicast sessions and the unicast sessions based on network information or the number of missed data blocks in one or a plurality of the transmission windows per client device, the sessions differing by:
which data blocks are to be transmitted in the session;
when the data blocks are transmitted;
the transmission window lengths;
network settings; and/or
transmission settings.

12. The network device of claim 1, wherein the instructions when executed by the processor circuitry cause the network device to become operative to:
initiate transmission of information indicative of one or more sessions assigned to the client device; and/or
initiate transmission of information for initialization of one or more sessions.

13. The network device of claim 10, wherein the instructions when executed by the processor circuitry cause the network device to become operative to:
determine the length of transmission windows of the sessions, the determining being based on:
the number of missing data blocks in one or a plurality of transmission windows from a previous multicast or unicast session to which the client device was previously assigned;
the number of data blocks in the data object;
the number of client devices; and/or
the gathered network information.

14. The network device of claim 10, and the transmission window is or one of the transmission windows comprise the finalization phase, and the instructions when executed by the processing circuitry cause the network device to become operative to:
initiate the release of the session for the client device once the finalization phase of the client device and belonging to the session has elapsed.

15. The network device of claim 9, wherein the instructions when executed by the processor circuitry cause the network device to become operative to:
decide, using the gathered network information, to transmit the missing data block to the client device via unicast and/or multicast.

16. The network device of claim 9, wherein the instructions when executed by the processor circuitry cause the network device to become operative to:
decide, using the gathered network information, to first, before any retransmissions, transmit the data blocks of the data object to the client device via multicast and/or unicast.

17. The network device of claim 1, wherein the instructions when executed by the processing circuitry cause the network device to be operative to:
decide to cease transmission of the missing data block based on:
the data block being missed by the client device in one or more of the associated transmission windows; and/or
the gathered network information.

18. A method, performed by a network device, for assisting in the retransmission of missing data blocks from a multicast transmission of a data object from an application server to a client device using Constrained Application Protocol (CoAP) the method comprising:
informing the client devices of a multicast repair functionality enabled by the network device;
receiving at least one indication of at least one missing data block from a client device of the client devices that did not successfully receive all data blocks of the data object within at least one transmission window of an earlier transmission in the communication associated with the client device and the transmission window or one of the transmission windows is or comprises a finalization phase;
deciding to transmit the one or more missing data blocks to the client device via unicast or multicast or both unicast and multicast;
initiating a transmission of the one or more missing data blocks according to the decision; and
ending the communication of the data object once the finalization phase has elapsed.

19. The method of claim 18, the method comprising:
determining the one or more transmission windows corresponding to the one or more missing data blocks of the client device, the transmission windows being or comprising:
a retransmission window that defines how long the client device should wait to receive one or more missing data blocks before indicating that the one or more data blocks have been missed;
a correction window that defines how long the client device should wait after communicating that the one or more missing data blocks are missing before reporting an error in the communication of the one or more data blocks; and/or
a finalization phase that defines how long the communication should remain open.

20-36. (canceled)

37. A non-transitory computer readable storing medium storing a computer program for configuring a network node to perform a method comprising:
informing the client devices of a multicast repair functionality enabled by the network device;
receiving at least one indication of at least one missing data block from a client device of the client devices that did not successfully receive all data blocks of the data object within at least one transmission window of an earlier transmission in the communication associated with the client device and the transmission window or one of the transmission windows is or comprises a finalization phase;
deciding to transmit the one or more missing data blocks to the client device via unicast or multicast or both unicast and multicast; and
initiating a transmission of the one or more missing data blocks according to the decision; and
ending the communication of the data object once the finalization phase has elapsed.
